(19) United States
(12) Patent Application Publication
(10) Pub. No.: US 2002/0175807 A1
(43) Pub. Date: Nov. 28, 2002

(54) IDENTIFICATION DEVICE

(76) Inventor: TERRENCE KEITH ASHWIN, RANDPARK RIDGE (ZA)

Correspondence Address: LADAS & PARRY, 26 WEST 61ST STREET, NEW YORK, NY, 10023, US

(21) Appl. No.: 09/260,285

(22) Filed: Mar. 2, 1999

(30) Foreign Application Priority Data
Mar. 2, 1998 (ZA) 98/1719

(51) Int. Cl. H04Q 5/22

(52) U.S. Cl. 340/10.51

(57) ABSTRACT

An electronic tag 10 is provided which includes magnetic sensing means 18 which is operable to sense a change in a magnetic field in order to program the tag 10. Typically, the tag 10 includes microprocessor based circuitry 14 including storage means 20, the microprocessor based circuitry 14 being programmable in response to activation of the magnetic sensing means 18. The tag 10 further includes transmitter means 12 connected to the microprocessor based circuitry 14 and operable selectively to transmit data sourced from the microprocessor based circuitry 14. Accordingly, the microprocessor based circuitry 14 may include a microcontroller which has one of its input ports connected to the contact of the magnetic sensing means 18, typically a reed switch or the like, for feeding data into the microcontroller. In response to activation of the reed switch, the microcontroller may enter into a programming mode, a monitoring mode, or the like.

THIS INVENTION relates to an identification device. It relates in particular to an electronic tag and to a method of feeding data into an electronic tag. It also relates to an electronic tag programming installation.

Electronic tags, e.g. including transponder devices and the like, are commonly available in the market place. In order to feed or program information into such tags, hardwired connections are typically used.

According to the invention, there is provided an electronic tag which includes magnetic sensing means which is operable to sense a change in a magnetic field in order to program the tag.

Typically, the electronic tag includes

microprocessor based circuitry including storage means, the microprocessor based circuitry being programmable in response to activation of the magnetic sensing means; and

transmitter means connected to the microprocessor based circuitry and operable selectively to transmit data sourced from the microprocessor based circuitry.

The microprocessor based circuitry may include a microcontroller which has one of its input ports connected to a contact of the magnetic sensing means for feeding data into the microcontroller.

The microcontroller is typically programmed to monitor the sensing means and, dependent upon the nature of activation or switching of the sensing means, enter into at least one different mode of operation e.g. a programming mode, data input mode, or the like.

The microcontroller may be programmed to sense a predetermined number of times the sensing means is activated and enter into the different mode of operation in response thereto. In certain embodiments the microcontroller monitors a time duration between successive activation of the sensing means and, dependent upon the time duration, enters into at least one different mode of operation.

The microcontroller may selectively enter into a programming mode in which binary data is defined in the microcontroller dependent upon the nature of activation of the sensing means. For example, once the microcontroller chip is switched into its programming mode, it may be arranged to enter into a data input mode in which data is input into its storage means via the sensing means.

The microcontroller may be configured so that data for a plurality of data fields is defined by activation of the sensing means. The microcontroller may be arranged so that, when a predetermined time delay in activation of the sensing means has occurred, a subsequent data field is then addressed.

The microcontroller may upon activation of the sensing means in a predetermined manner enter into a monitoring mode of operation in which the tag performs a monitoring function.

The sensing means may thus be multi-purpose in that it may switch the microprocessor based circuitry into a program mode and also function in a data input mode. Once the tag has been programmed, the sensing means may perform a monitoring function, e.g. monitoring opening and closing of a door in response to displacement of a permanent magnet in its proximity, function as a magnetic counter, or the like.

In other embodiments, the tag is programmed with unique identification data identifying the object or person to which it is attached in use, e.g. a person's name, the contents of a container, and so on.

The transmitter means may be a radio frequency transmitter arranged intermittently to transmit encoded digital data, e.g. in a conventional fashion, to reading apparatus.

In certain embodiments, the magnetic sensing means is a reed switch which is selectively switched by an external magnetic field. The microcontroller may be a conventional integrated circuit with an input port connected to the reed switch. The other contact of the reed switch may be pulled high by a resistor. The resistor typically has a high value in order to reduce the current flowing through the reed switch and thereby increase power consumption efficiency of the tag.

Instead, the magnetic sensing means may be a device designed to operate on the Hall effect.

The electronic tag may include an encapsulation of a resinous material.

The electronic tag may be an active tag including its own power source, e.g. a long-life lithium battery.

Further in accordance with the invention, there is provided a method of feeding data into an electronic tag including microprocessor based circuitry connected to magnetic sensing means, the method including

selectively providing a magnetic field in proximity to the magnetic sensing means; and

automatically monitoring the magnetic sensing means by means of the microprocessor based circuitry and programming the microprocessor based circuitry of the electronic tag in response to changes in the magnetic field.

The electronic tag may be programmed manually by physically displacing a permanent magnet in proximity to the magnetic sensing means. However, in other embodiments, the electronic tag is programmed automatically by energising an electromagnetic field selectively activated by a programming installation.

Still further in accordance with the invention, there is provided an electronic tag programming installation for programming an electronic tag including magnetic sensing means, the installation including

magnetic field generating means proximate which the electronic tag is positioned in use;

data input means for receiving data which is to be programmed into the tag; and

control means responsive to the data input means and connected to the magnetic field generating means, the control means being operable selectively to activate the magnetic field generating means to activate magnetic sensing means of the tag and thereby program the tag.

The control means may be defined by a personal computer.

The invention is now described, by way of example, with reference to the accompanying diagrammatic drawings.

In the drawings,

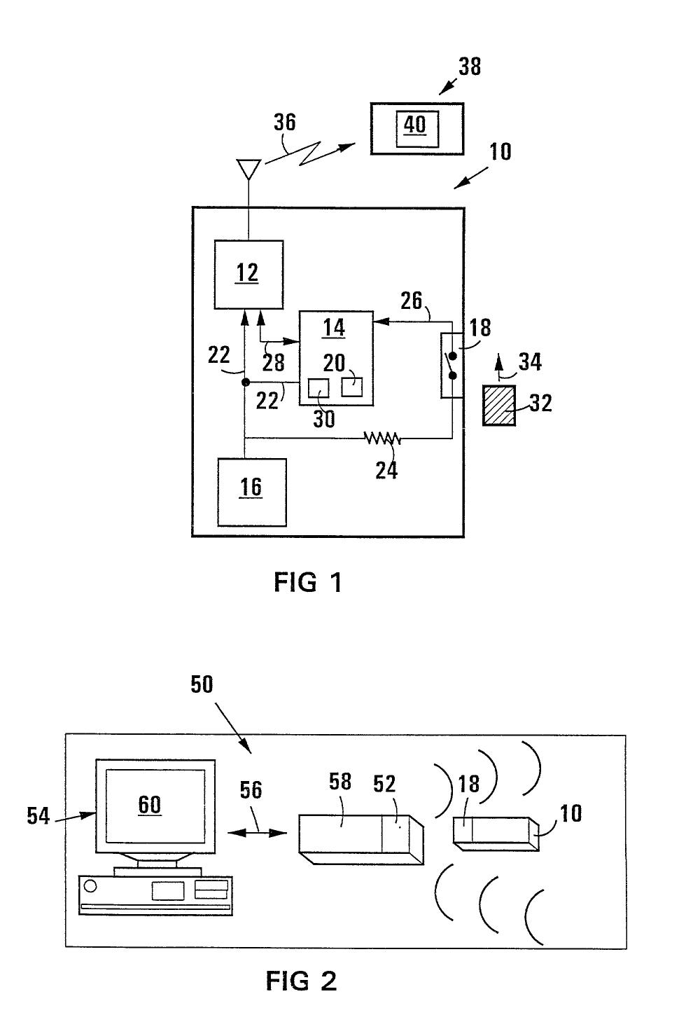

FIG. 1 shows a schematic block diagram of an electronic tag in accordance with the invention; and

FIG. 2 shows a schematic block diagram of an electronic tag programming installation, also in accordance with the invention.

Referring to the drawings, reference numeral 10 generally indicates an electronic tag in accordance with the invention. The tag 10 includes a transmitter 12, a microcontroller chip 14, a long-life lithium battery 16, and magnetic sensing means in the form of a reed switch 18. As will be described in more detail below, the reed switch 18 performs multiple functions and may be used to switch the microcontroller chip 14 into a program mode as well as enter data into onboard storage means or memory 20.

The lithium batter 16 is connected via lines 22 to the transmitter 12 and to the microcontroller chip 14. Further, the battery 16 is connected via a resistor 24 to a contact of the reed switch 18, the other contact of the reed switch 18 being connected via line 26 to an input port of the microcontroller chip 14. The value of the resistor 24 is of a high magnitude thereby to limit the current selectively flowing through the reed switch 18 and thereby enhance power consumption efficiency of the electronic tag 10. The microcotroller chip 14 is connected to the transmitter 12 via a bi-directional link 28.

The microcontroller chip 14 is programmed to include a counter facility 30 selectively to count each time contacts of the reed switch 18 are closed. In order selectively to close the contacts of the reed switch 18, a permanent magnet 32, for example, is intermittently displaced in the direction of arrow 34 thereby intermittently and selectively to toggle the reed switch 18. In response to the initial toggling of the reed switch 18, the microcontroller chip 14 enters into a program mode in which unique identification data associated with an object to which the electronic tag 10 is to be attached, is fed into the memory 20. In order to facilitate programming of the tag 10, its present mode of operation and data included in various programmable data fields is transmitted via the transmitter 12, and as shown by arrow 36, to reading apparatus 38 which has an LCD screen 40 to display the information.

The microcontroller chip 14 includes a pre-programmed software routine to monitor switching of the reed switch 18 and is arranged so that, dependent upon the number of times the reed switch 18 is toggled as well as the time duration between subsequent toggling of the reed switch 18, it enters various different modes as displayed by the LCD screen 40 of the reading apparatus 38. For example, if the preprogrammed software recognises that reed switch 18 has been switched in such a fashion instructing it to go into a program mode, subsequent toggling or switching may then represent data to be fed into the microcontroller chip 14. Upon recognition of a further predetermined code or sequence of switching of the reed switch 18, the mircocontroller chip 14 may then exit the program mode.

Once the selected information has been programmed into the tag 10, the reed switch 18 may perform a monitoring function operable to monitor changes in the magnetic field and, in response thereto, increment the counter of the counter facility 30. Accordingly, in certain applications of the invention, the tag 10 may be used to monitor the opening and closing of doors, windows, or the like.

Referring in particular to FIG. 2 of the drawings, reference numeral 50 generally indicates an electronic tag programming installation for programming the electronic tag 10 as hereinbefore described. The installation 50 includes magnetic field generating means in the form of an electromagnet 52 and data input means and control means defined by a personal computer (PC) 54. The PC 54 is connected to the electromagnet 52 and to a reading apparatus 58 via a bidirectional communication link 56.

In use, data to be programmed into the electronic tag 10 is fed into the PC 54 which then selectively energises the electromagnet 52 thereby to activate or switch the reed switch 18 of the tag 10 selectively and thereby program the tag 10. In order to monitor the internal mode of the microcontroller chip 14, the tag 10 intermittently transmits a digitally encoded data signal to the reading apparatus 58 and comprehensive details are then displayed on a screen 60 of the PC 54.

The Inventor believes that the invention, as illustrated, provides a relatively simpler electronic tag 10 which may be used in various different applications. The Inventor believes that it is an advantage of the invention that the electronic tag 10 may be programmed in a wireless fashion by switching the reed switch 18 thereby simplifying hardware requirements in order to program the electronic tag 10.

1. An electronic tag which includes magnetic sensing means which is operable to sense a change in a magnetic field in order to program the tag.

2. An electronic tag as claimed in claim 1, which includes microprocessor based circuitry including storage means, the microprocessor based circuitry being programmable in response to activation of the magnetic sensing means; and
transmitter means connected to the microprocessor based circuitry and operable selectively to transmit data sourced from the microprocessor based circuitry.

3. An electronic tag as claimed in claim 1, in which the microprocessor based circuitry includes a microcontroller which has one of its input ports connected to a contact of the magnetic sensing means for feeding data into the microcontroller.

4. An electronic tag as claimed in claim 3, in which the microcontroller is programmed to monitor the sensing means and, dependent upon the nature of activation of the sensing means, enter into at least one different mode of operation.

5. An electronic tag as claimed in claim 4, in which the microcontroller is programmed to sense a predetermined number of times the sensing means is activated and enter into the different mode of operation in response thereto.

6. An electronic tag as claimed in claim 4, in which the microcontroller monitors a time duration between successive activation of the sensing means and, dependent upon the time duration, enters into at least one different mode of operation.

7. An electronic tag as claimed in claim 4, in which the microcontroller selectively enters into a programming mode in which binary data is defined in the microcontroller dependent upon the nature of activation of the sensing means.

8. An electronic tag as claimed in claim 7, in which the microcontroller is configured so that data for a plurality of data fields is defined by activation of the sensing means, the microcontroller being arranged so that, when a predetermined time delay in activation of the sensing means has occurred, a subsequent data field is then addressed.

9. An electronic tag as claimed in claim 7, in which the microcontroller upon activation of the sensing means in a predetermined manner enters into a monitoring mode of operation in which the tag performs a monitoring function.

10. An electronic tag as claimed in claim 2, in which the transmitter means is a radio frequency transmitter arranged intermittently to transmit encoded digital data to reading apparatus.

11. An electronic tag as claimed in claim 2, in which the magnetic sensing means is a reed switch which is selectively switched by an external magnetic field.

12. An electronic tag as claimed in claim 1, in which the magnetic sensing means is a device designed to operate on the Hall effect.

13. An electronic tag as claimed in claim 1, which includes an encapsulation of a resinous material.

14. An electronic tag as claimed in claim 1, in which the tag is an active tag including its own power source.

15. A method of feeding data into an electronic tag including microprocessor based circuitry connected to magnetic sensing means, the installation including
selectively providing a magnetic field in proximity to the magnetic sensing means; and
automatically monitoring the magnetic sensing means by means of the microprocessor based circuitry and programming the microprocessor based circuitry of the electronic tag in response to changes in the magnetic field.

16. A method as claimed in claim 15, in which the electronic tag is programmed manually by physically displacing a permanent magnet in proximity to the magnetic sensing means.

17. A method as claimed in claim 15, in which the electronic tag is programmed automatically by energising an electromagnetic field selectively activated by a programming installation.

18. An electronic tag programming installation for programming an electronic tag including magnetic sensing means, the installation including
magnetic field generating means proximate which the electronic tag is positioned in use;
data input means for receiving data which is to be programmed into the tag; and
control means responsive to the data input means and connected to the magnetic field generating means, the control means being operable selectively to activate the magnetic field generating means to activate magnetic sensing means of the tag and thereby program the tag.

19. An installation as claimed in claim 18, in which the control means is defined by a personal computer.
